(19) United States
(12) Patent Application Publication
(10) Pub. No.: US 2020/0274118 A1
(43) Pub. Date: Aug. 27, 2020

(54) METHOD OF BATTERY MODULE ASSEMBLY AND BATTERY MODULE ASSEMBLY ARRANGEMENT

(71) Applicant: TIVENI MERGECO, INC., San Mateo, CA (US)

(72) Inventors: Heiner FEES, Bietigheim-Bissingen (DE); Andreas TRACK, Sachsenheim (DE); Ralf MAISCH, Abstatt (DE); Alexander EICHHORN, Eppingen (DE); Jörg DAMASKE, Freiberg (DE); Valentin BROKOP, Walheim (DE); Hans-Joachim PFLÜGER, Wüstenrot (DE); Claus Gerald PFLÜGER, Markgröningen (DE)

(21) Appl. No.: 16/799,595

(22) Filed: Feb. 24, 2020

Related U.S. Application Data
(60) Provisional application No. 62/810,144, filed on Feb. 25, 2019.

(51) Int. Cl. H01M 2/10

(52) U.S. Cl. CPC H01M 2/1077; H01M 2220/20

(57) ABSTRACT

In an aspect, a battery module is assembly by mounting first and second jig towers (e.g., monolithic or modular/stackable jig towers) on a surface. Battery cell(s) are arranged between the jig towers and fixed in position based in part on battery cell fixation elements arranged in the respective jig towers. At least one magnetic-based supplemental fixation element is used to apply magnetic force (e.g., attractive and/or repulsive magnetic force) so as to direct the battery cell(s) towards the first jig tower and away from the second jig tower (e.g., so that battery cells in respective rows will be flush with each other).

### CROSS-REFERENCE TO RELATED APPLICATIONS

The present application for patent claims the benefit of U.S. Provisional Application No. 62/810,114 with attorney docket no. TIV-180011P1, entitled “METHOD OF BATTERY MODULE ASSEMBLY AND BATTERY MODULE ASSEMBLY ARRANGEMENT”, filed Feb. 25, 2019, which is assigned to the assignee hereof and hereby expressly incorporated by reference herein in its entirety.

### BACKGROUND

### 1. Field of the Disclosure

Embodiments relate to a method of battery module assembly and a battery module assembly arrangement.

### 2. Description of the Related Art

Energy storage systems may rely upon batteries for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are electrical connected (series and/or parallel) to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

### SUMMARY

An embodiment is directed to a method of battery module assembly, comprising mounting a first jig tower on a surface, mounting a second jig tower on the surface, arranging a set of battery cells arranged between a first part of the first jig tower that includes a first set of battery cell fixation elements and a second part of the second jig tower that opposes the first part of the first jig tower and is arranged with a second set of battery cell fixation elements, the set of battery cells each being fixed in position at least in part by the first and second sets of fixation elements, and applying magnetic force to each battery cell in the set of battery cells in a direction that is towards the first jig tower and away from the second jig tower.

Another embodiment is directed to a battery module assembly arrangement, comprising a first jig tower mounted on a surface, a second jig tower mounted on the surface, a set of battery cells arranged between a first part of the first jig tower that includes a first set of battery cell fixation elements and a second part of the second jig tower that opposes the first stackable jig and is arranged with a second set of battery cell fixation elements, the set of battery cells each being fixed in position at least in part by the first and second sets of fixation elements, and at least one magnetic-based supplemental fixation element configured to apply magnetic force to each battery cell in the set of battery cells in a direction that is towards the first jig tower and away from the second jig tower.

### BRIEF DESCRIPTION OF THE DRAWINGS

A more complete appreciation of embodiments of the disclosure will be readily obtained as the same becomes better understood by reference to the following detailed description when considered in connection with the accompanying drawings, which are presented solely for illustration and not limitation of the disclosure, and in which:

FIG. 1 illustrates an example metal-ion (e.g., Li-ion) battery in which the components, materials, methods, and other techniques described herein, or combinations thereof, may be applied according to various embodiments.

FIG. 2 illustrates a high-level electrical diagram of an exemplary battery module that shows P groups 1 . . . N connected in series in accordance with an embodiment of the disclosure.

FIG. 3A illustrates a battery module during assembly after battery cells are inserted therein.

FIGS. 3B-3D illustrate the general arrangement of contact plate(s) with respect to battery cells of a battery module.

FIGS. 4-16B illustrate a battery module assembly procedure in accordance with an embodiment of the disclosure.

FIG. 17 illustrates two variants of pin arrangements in an assembly device.

FIG. 18 illustrates a process of battery module assembly in accordance with an embodiment of the disclosure.

FIGS. 19A-19F each depict a battery module assembly arrangement with jig towers comprised of respective sets of stackable jigs at successive stages of assembly based on an example implementation of the process of FIG. 18 in accordance with an embodiment of the disclosure.

FIG. 20 illustrates a battery module assembly arrangement based on an example implementation of the process of FIG. 18 in accordance with another embodiment of the disclosure.

### DETAILED DESCRIPTION

Embodiments of the disclosure are provided in the following description and related drawings. Alternate embodiments may be devised without departing from the scope of the disclosure. Additionally, well-known elements of the disclosure will not be described in detail or will be omitted so as not to obscure the relevant details of the disclosure.

Energy storage systems may rely upon batteries for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are connected to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

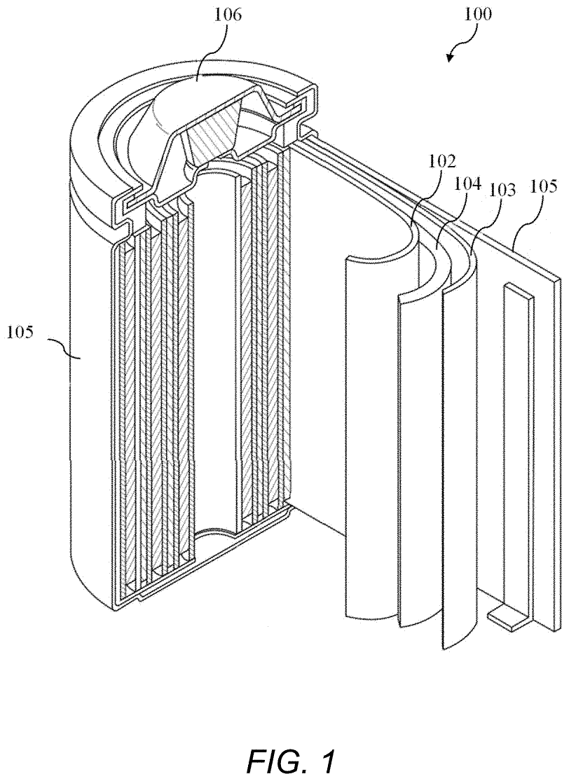

FIG. 1 illustrates an example metal-ion (e.g., Li-ion) battery in which the components, materials, methods, and other techniques described herein, or combinations thereof, may be applied according to various embodiments. A cylindrical battery cell is shown here for illustration purposes, but other types of arrangements, including prismatic or pouch (laminate-type) batteries, may also be used as desired. The example battery 100 includes a negative anode 102, a positive cathode 103, a separator 104 interposed between the anode 102 and the cathode 103, an electrolyte (shown implicitly) impregnating the separator 104, a battery case 105, and a sealing member 106 sealing the battery case 105.

Embodiments of the disclosure relate to various configurations of battery modules that may be deployed as part of an energy storage system. In an example, while not illustrated expressly, multiple battery modules in accordance with any of the embodiments described herein may be deployed with respect to an energy storage system (e.g., chained in series to provide higher voltage to the energy storage system, connected in parallel to provide higher current to the energy storage system, or a combination thereof).

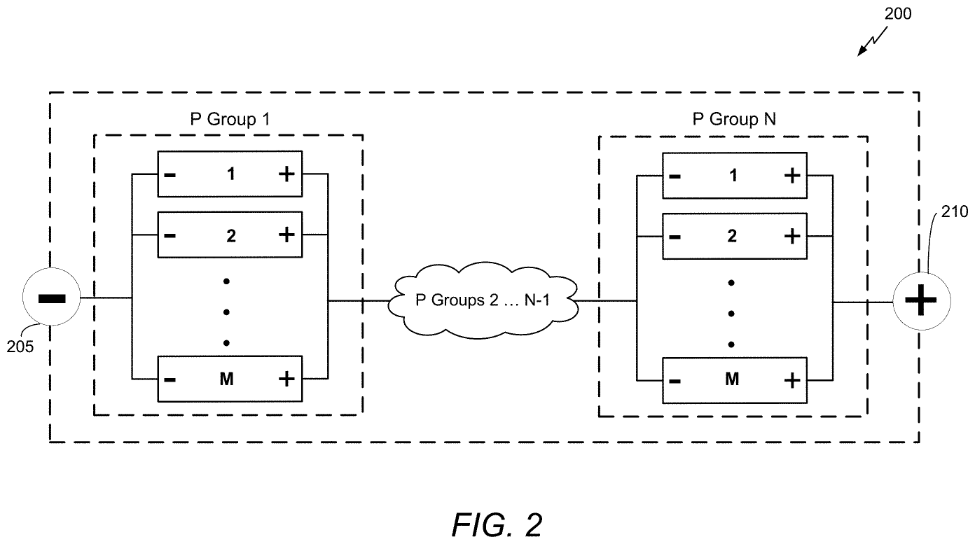

FIG. 2 illustrates a high-level electrical diagram of a battery module 200 that shows P groups 1 . . . N connected in series in accordance with an embodiment of the disclosure. In an example, N may be an integer greater than or equal to 2 (e.g., if N=2, then the intervening P groups denoted as P groups 2 . . . N−1 in FIG. 1 may be omitted). Each P group includes battery cells 1 . . . M (e.g., each configured as shown with respect to battery cell 100 of FIG. 1) connected in parallel. The negative terminal of the first series-connected P group (or P group 1) is coupled to a negative terminal 205 of the battery module 200, while the positive terminal of the last series-connected P group (or P group N) is connected to a positive terminal 210 of the battery module 200. As used herein, battery modules may be characterized by the number of P groups connected in series included therein. In particular, a battery module with 2 series-connected P groups is referred to as a “2S” system, a battery module with 3 series-connected P groups is referred to as a “3S” system, and so on.

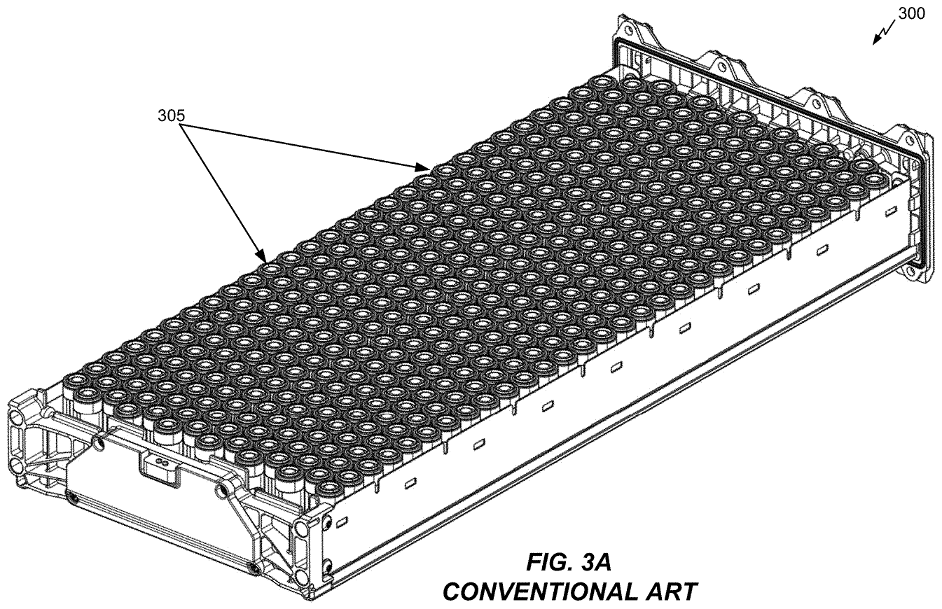

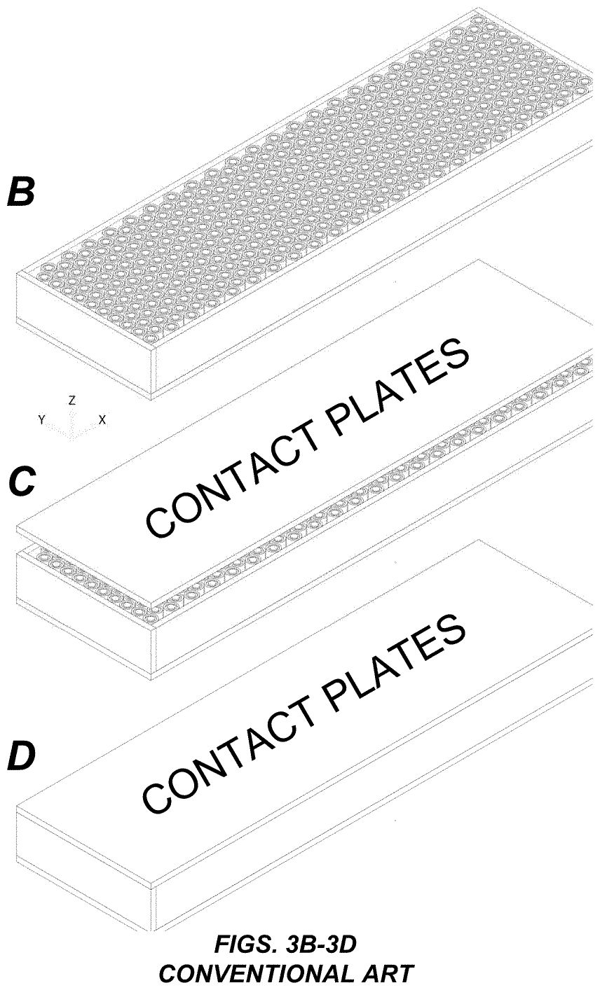

FIG. 3A illustrates a battery module 300A during assembly after battery cells 305A are inserted therein. In some designs, both the positive terminal (cathode) and negative terminal (anode) of the battery cells in the battery module 300A may be arranged on the same side (e.g., the top side). For example, the centered cell ‘head’ may correspond to the positive terminal, while the outer cell rim that rings the cell head may correspond to the negative terminal. In such a battery module, the P groups are electrically connected in series with each other via a plurality of contact plates arranged on top of the battery cells 305.

FIGS. 3B-3D illustrate the general arrangement of contact plate(s) with respect to battery cells of a battery module. As shown in FIGS. 3B-3D, the contact plates may be arranged on top of the battery cells in close proximity to their respective positive and negative terminals in some designs.

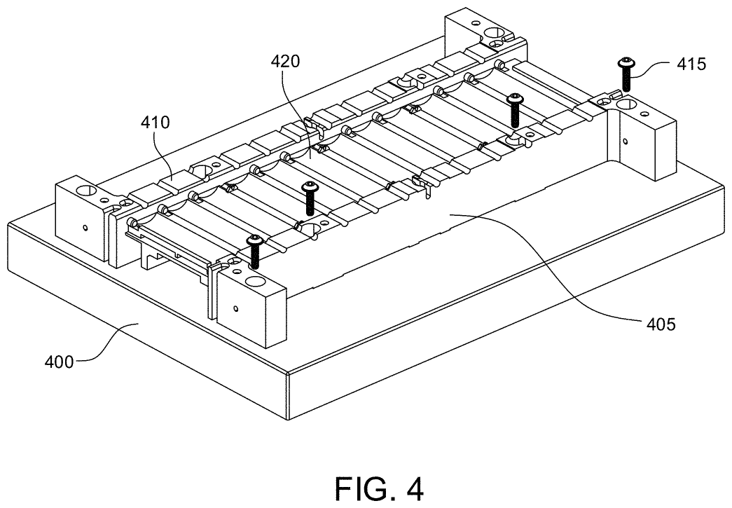

FIGS. 4-16B illustrate a battery module assembly procedure in accordance with an embodiment of the disclosure.

Referring to FIG. 4, the battery module begins construction on a base plate onto which jigs (plus side and minus side) are mounted (e.g., via screws). The jigs are stackable, as will be discussed below in more detail. An external frame component of the battery module is arranged between the jigs. As used herein, the “minus side” of the battery cell refers to the side of the battery cell that opposes the positive terminal of the battery cell. For certain implementations, battery cells with positive and negative terminals arranged on the same side may be used (e.g., a positive cell head surrounded by a negative cell rim), in which case the “minus side” does not necessarily correspond to the negative terminal of a respective battery cell.

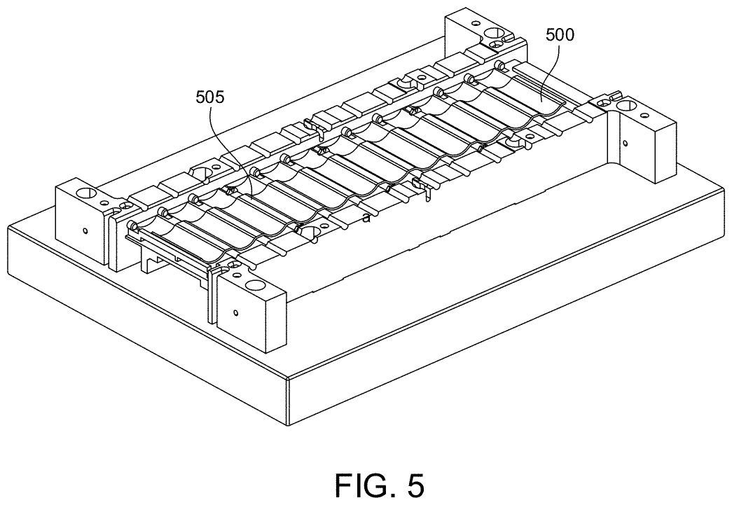

Referring to FIG. 5, an insulative layer is glued onto the external frame component via a dispensing machine.

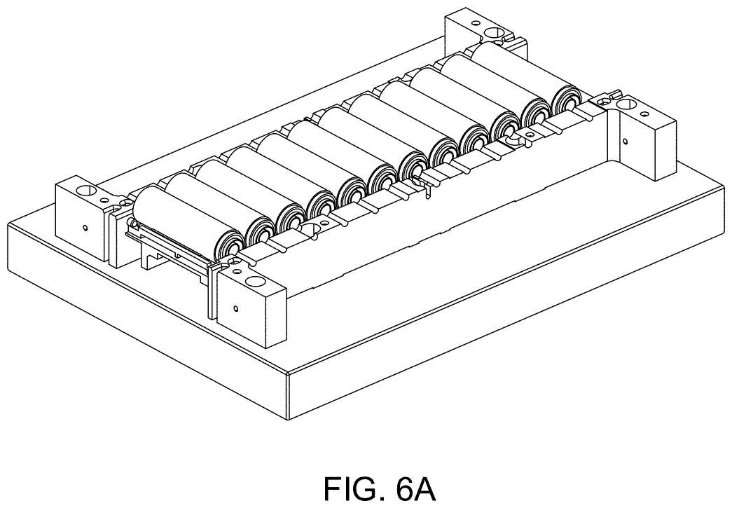

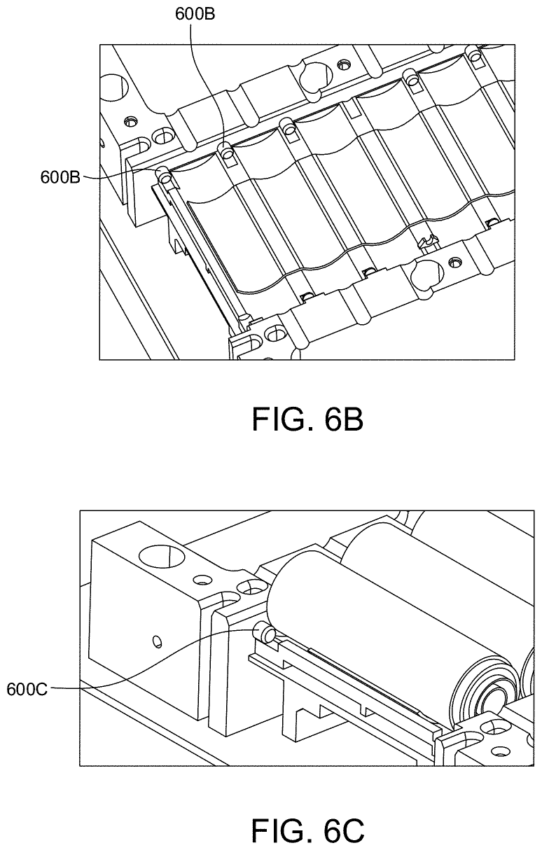

Referring to FIG. 6A, a cell layer 1 is placed onto the insulative layer. In the embodiment of FIG. 6A, the cell layer 1 includes 12 cylindrical battery cells that are each part of the same P Group. FIGS. 6B-6C demonstrate how pins arranged on the respective jigs can be used to fix the position of each cell in the cell layer 1. In an example, magnets may be integrated into each minus side jig to pull the respective cells of each cell layer so that the minus side of each cell layer is flush.

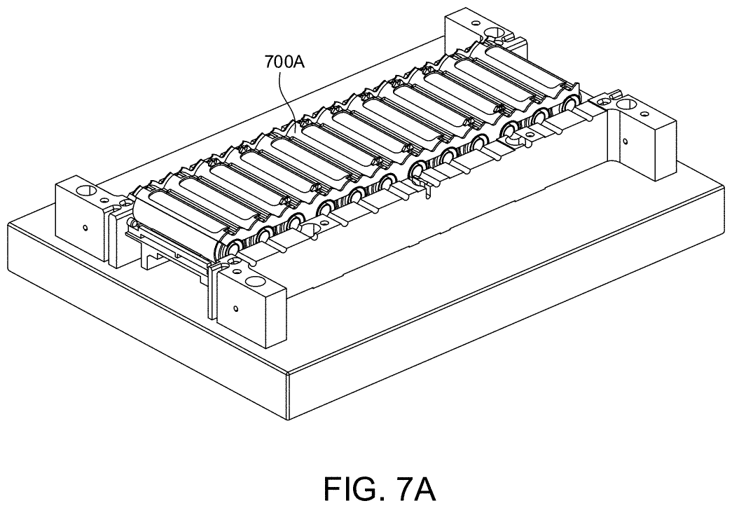

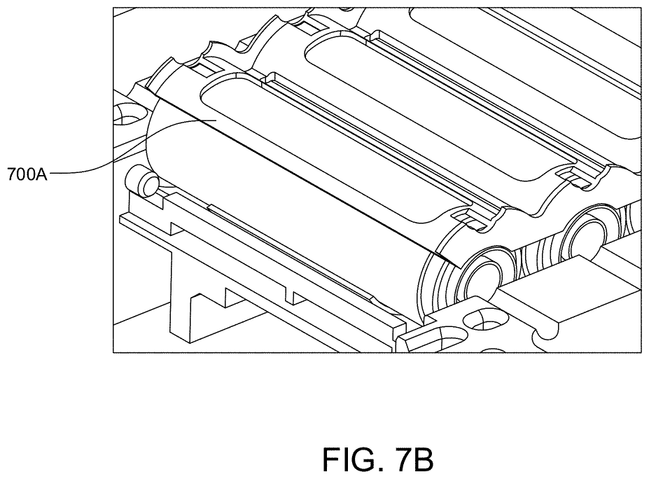

Referring to FIG. 7A, a spacer is added on top of the cell layer 1. The spacer is arranged to define a spacing between the cell layer 1 and a cell layer 2. In an example, the spacer may comprise a piece or several pieces (e.g., made from plastic).

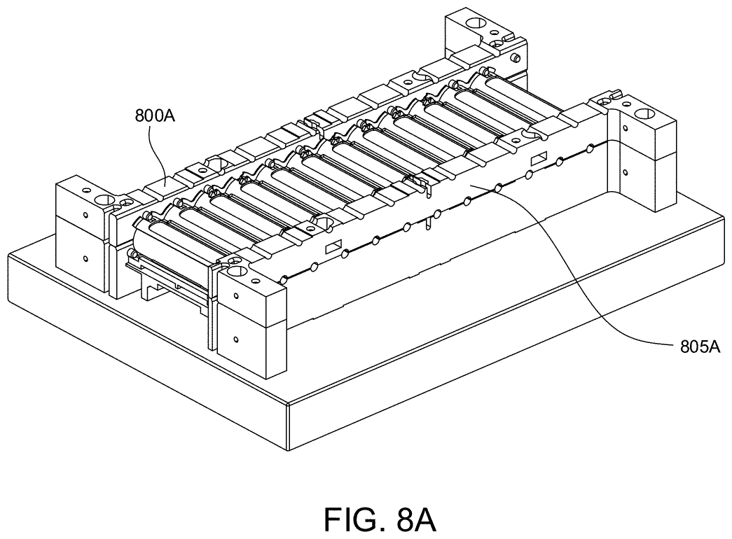

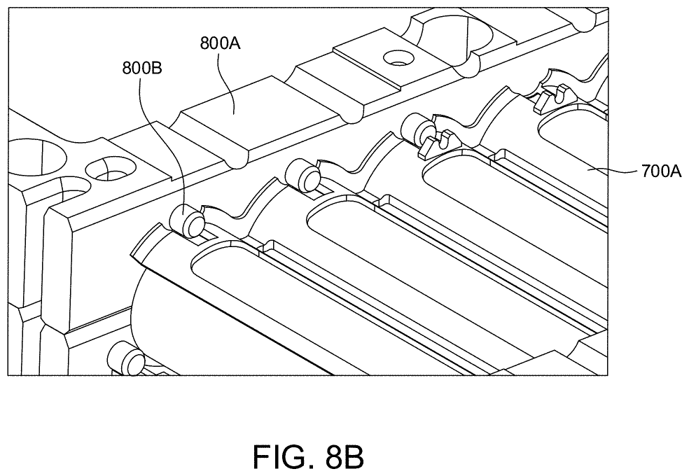

Referring to FIG. 8A, jigs (minus side and plus side) for the cell layer 2 are stacked onto the jigs for the cell layer 1. As shown more clearly in FIG. 8B, notches in the spacer between cell layers 1 and 2 are aligned with pins on the jigs for the cell layer 2.

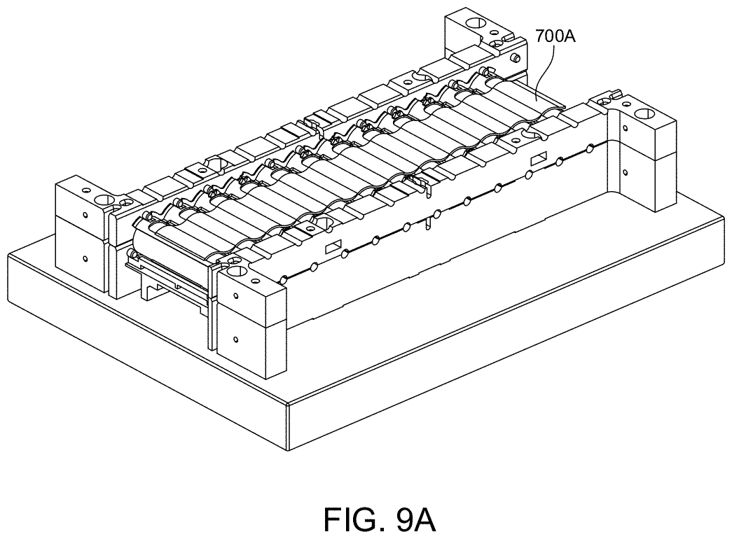

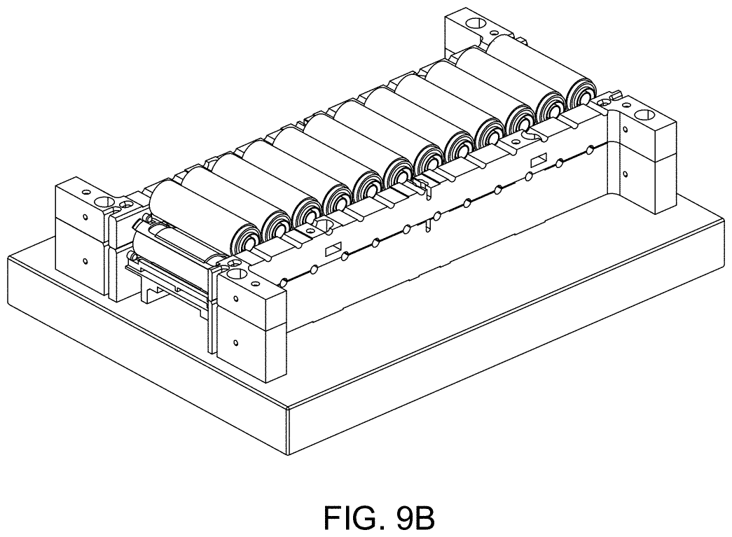

Referring to FIG. 9A, an insulative layer is placed on the spacer between cell layers 1 and 2. While not shown expressly in FIG. 9A, glue may be applied to the insulative layer.

Referring to FIG. 9B, the cell layer 2 is placed onto the insulative layer and secured via the glue. In the embodiment of FIG. 9B, the cell layer 2 includes 12 cylindrical battery cells that are each part of the same P Group. The P Group of cell layer 2 may be the same or different from the P Group of cell layer 3, depending on the configuration of contact plate(s) used in the battery module (described below in more detail).

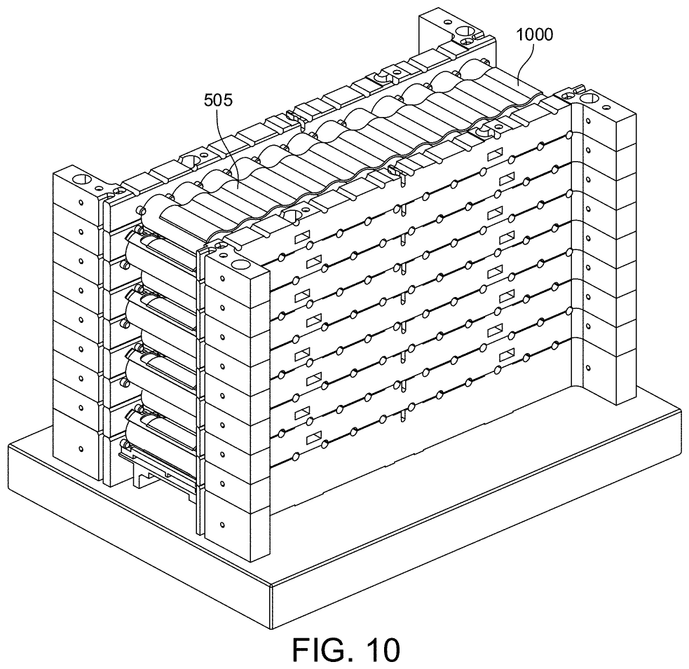

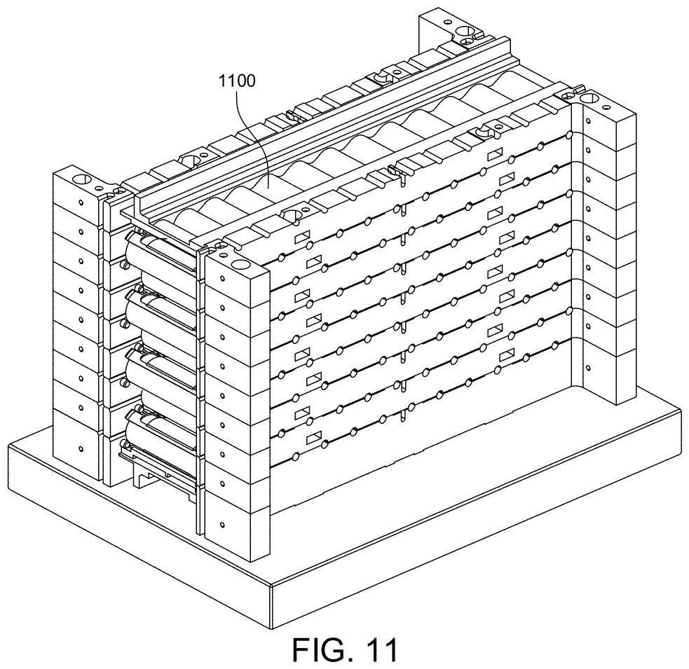

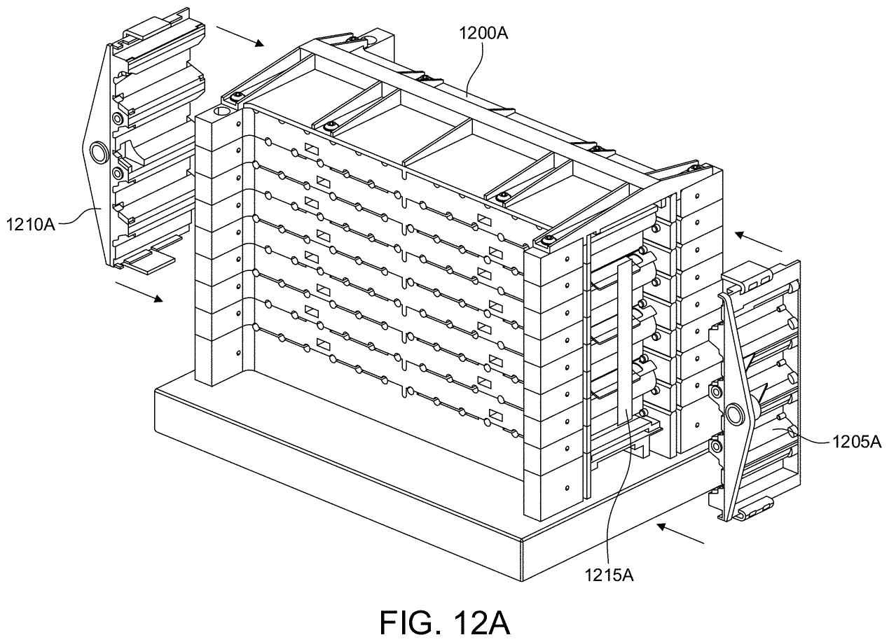

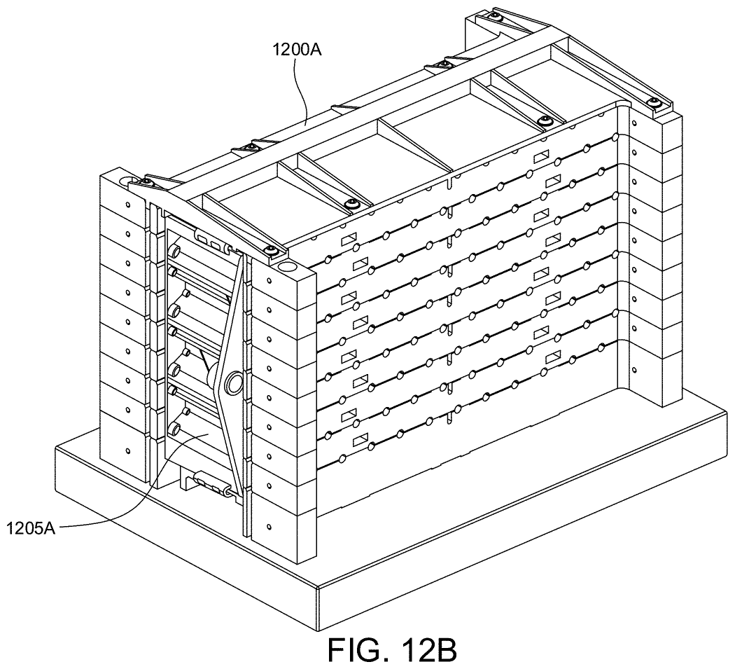

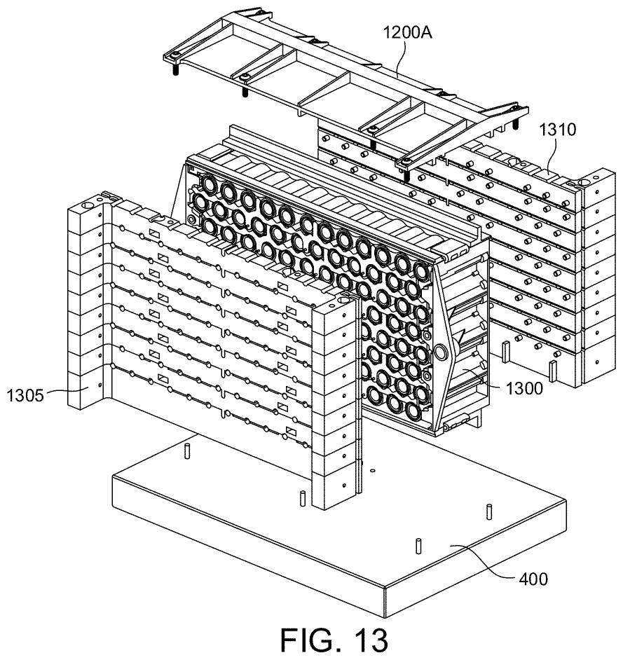

At this point, the processes depicted in FIGS. 7A-9B may repeat a given number of times until a desired number of cell layers are constructed, resulting in the arrangement depicted in FIG. 10 including cell layers 1-8. As shown in FIG. 10, glue is applied to the top-most insulative layer, after which another external frame component is attached to the top-most insulative layer as shown in FIG. 11. As shown in FIGS. 12A-12B, a top jig is added, after which opposing sidewalls are attached via glue. The battery module is then separated from the respective jigs and the base plate as shown in FIG. 13.

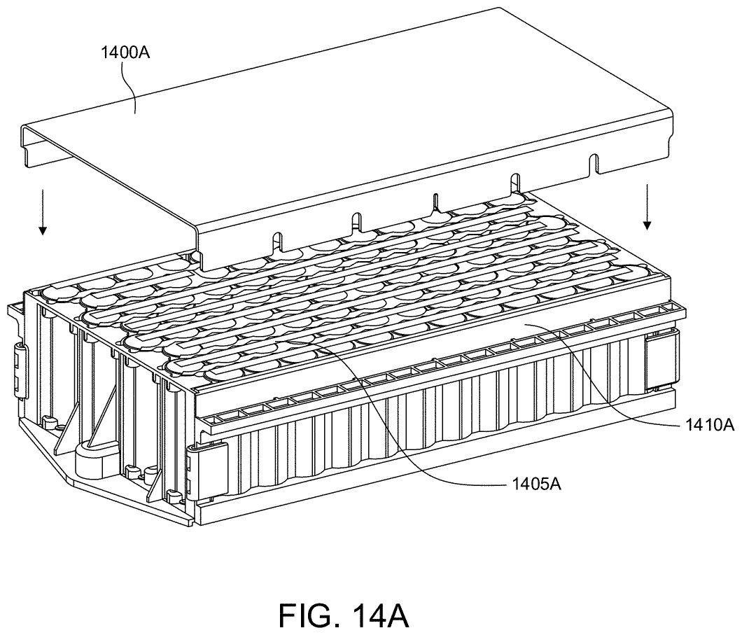

Referring to FIGS. 14A-14B, a bottom plate is secured to the battery module via glue.

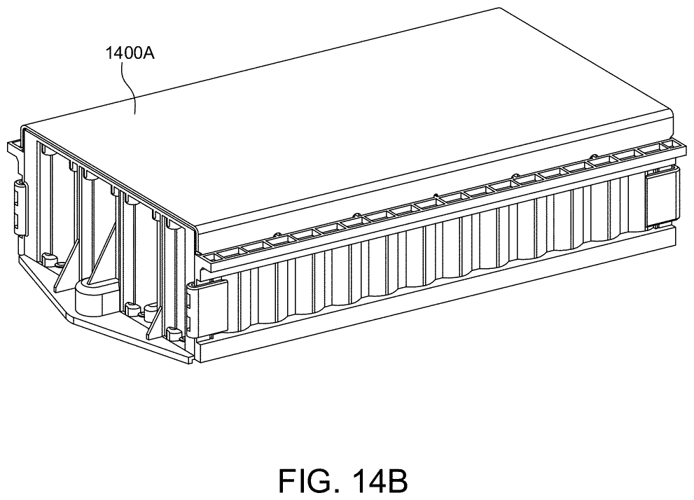

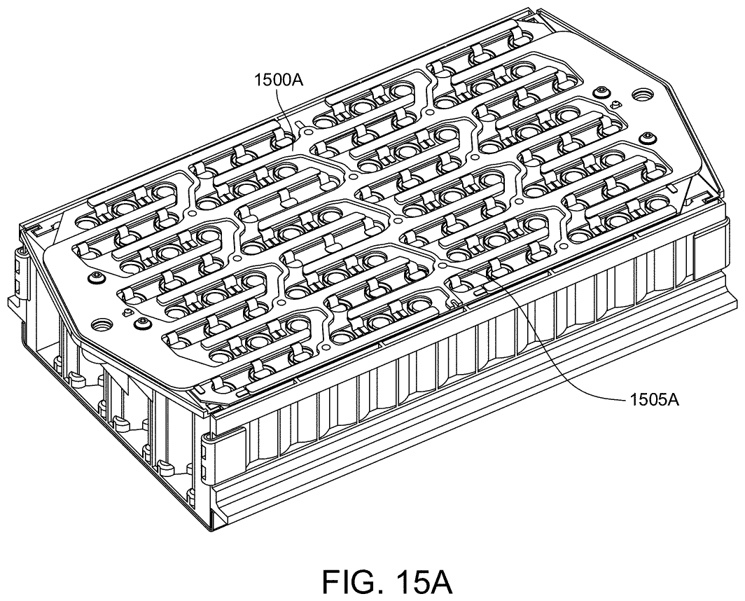

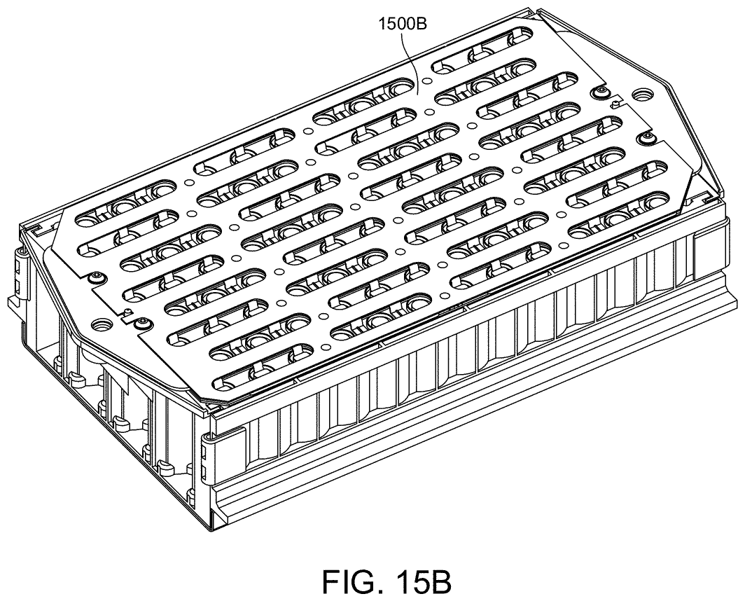

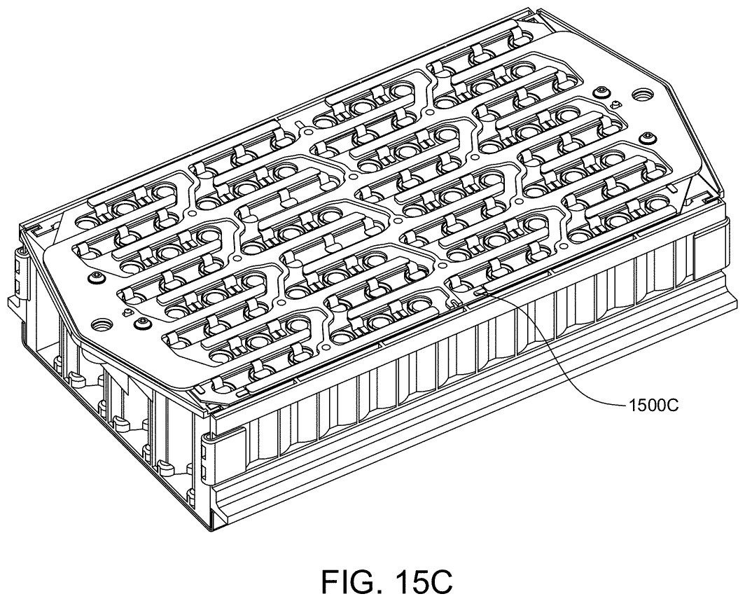

Referring to FIG. 15A, a conductive plate (or contact plate) is arranged over the battery cells (e.g., fixed with glue). FIG. 15B depicts an alternative contact plate that comprises 2-layer foil. Examples of contact plates are described at least with respect to FIGS. 7A-8B of U.S. Patent Publication No. 2018/0108886A1, entitled “Multi-layer contact plate configured to establish electrical bonds to battery cells in a battery module”, and hereby incorporated by reference in its entirety. Referring to FIG. 15C, the contact plate of FIG. 15A may further include contact tabs onto which sensor wire may be connected (e.g., thermistors).

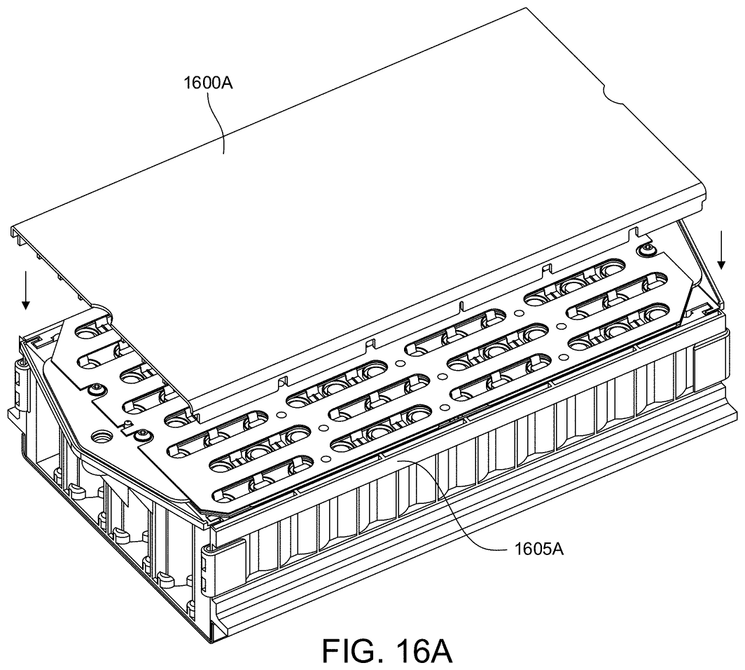

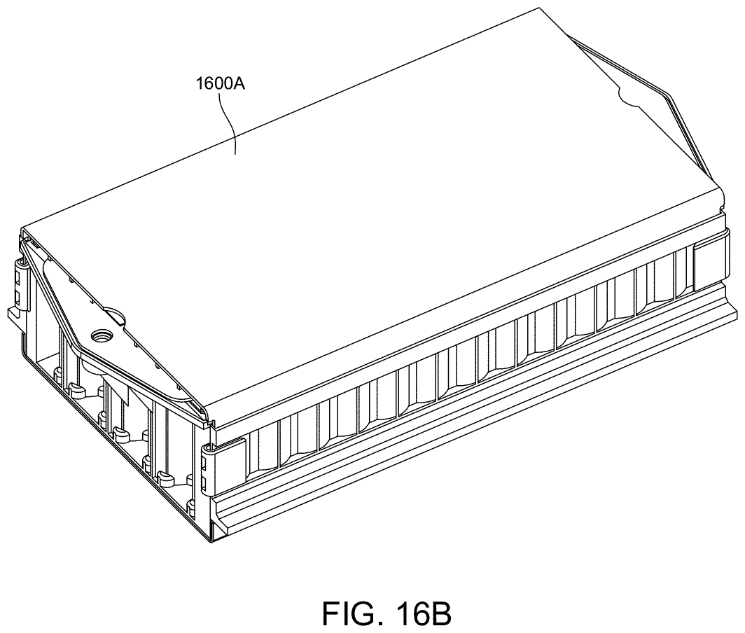

Referring to FIGS. 16A-16B, a cover is added to the battery module (e.g., via glue). At this point, the battery module is complete and may be deployed as part of an energy storage system (e.g., for an electric vehicle). The external parts of the battery module (e.g., external frame components, sidewalls, bottom plate and cover) collectively comprise a battery housing for the battery cells contained therein.

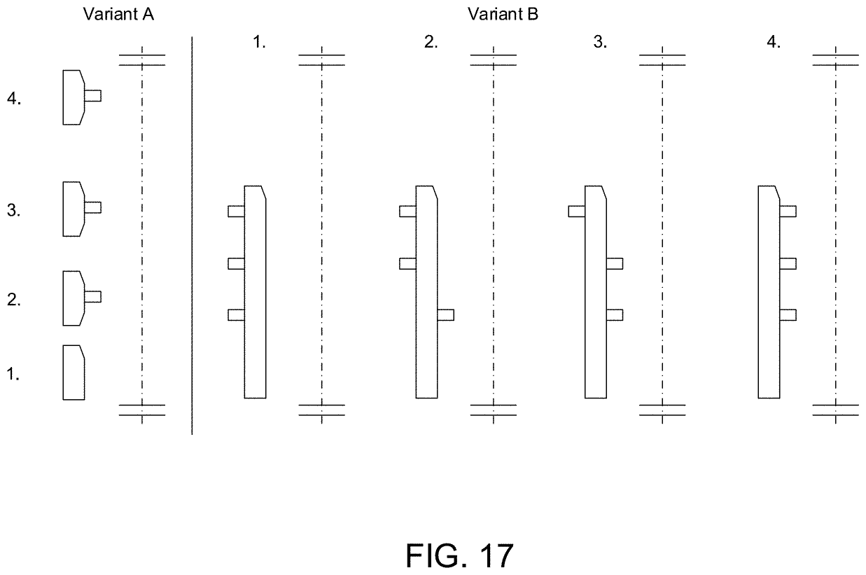

FIG. 17 illustrates two variants of pin arrangements in the assembly device (i.e., in the minus side and plus side jigs). In variant A, the pins are fixed on different jigs and are added when each new jig is added as illustrated in FIGS. 4-16B. In variant B, a jig tower that comprises a plurality of stacked jigs and/or a single large structure (one large jig comprising multiple cell layers) is used, whereby pins can be set to a withdrawn position (not inserted) or an inserted position. In variant B(1), each pin of the jig tower is withdrawn. In variant B(2), the pin for cell layer 1 is inserted. In variant B(3), the pin for cell layers 1 and 2 are inserted. In variant B(3), the pin for cell layers 1-3 are inserted. As will be appreciated, the jig tower can span any number of cell layers, and multiple jig towers and/or individual jigs can be stacked together as well.

In some designs, a battery module may be integrated with a cooling plate on one end of a set of cylindrical battery cells (e.g., underneath the cells). In such implementation, cooling efficiency is improved if the set of cylindrical battery cells are substantially flush against the cooling plate (e.g., although thermal paste can also be used to bridge gaps therebetween). In some designs, electrical terminal connections may be formed on one end (or in some designs, both ends) of the set of cylindrical battery cells. In such designs, precise fixation of the battery cells can simplify the process of welding the battery cell terminals to one or more contact plates.

Conventional methodologies to obtain the above-noted cell fixation uniformity generally rely upon a mechanical fixture (or clamping device) that (in addition to fixation pins) holds the battery cells in place while glue is applied thereon. Once the glue cures, the mechanical fixture is removed. However, the application and subsequent removal of such a mechanical fixture adds both time and complexity to the battery module assembly process. Hence, embodiments of the disclosure are directed to a battery module assembly arrangement and method thereof whereby magnetic force is used to achieve the above-noted cell position uniformity without requiring the use of such a mechanical fixture.

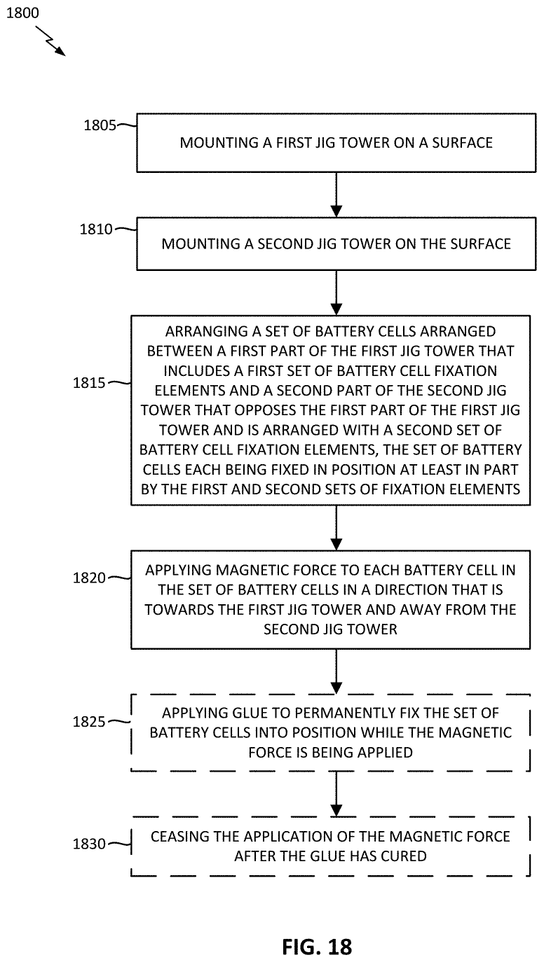

FIG. 18 illustrates a process 1800 of battery module assembly in accordance with an embodiment of the disclosure. At block 1805, a first jig tower is mounted on a surface (e.g., a base plate). At block 1810, a second jig tower is mounted on the surface (e.g., a base plate). Example implementations of blocks 1805-1810 are shown at FIGS. 4, 8A, and 10.

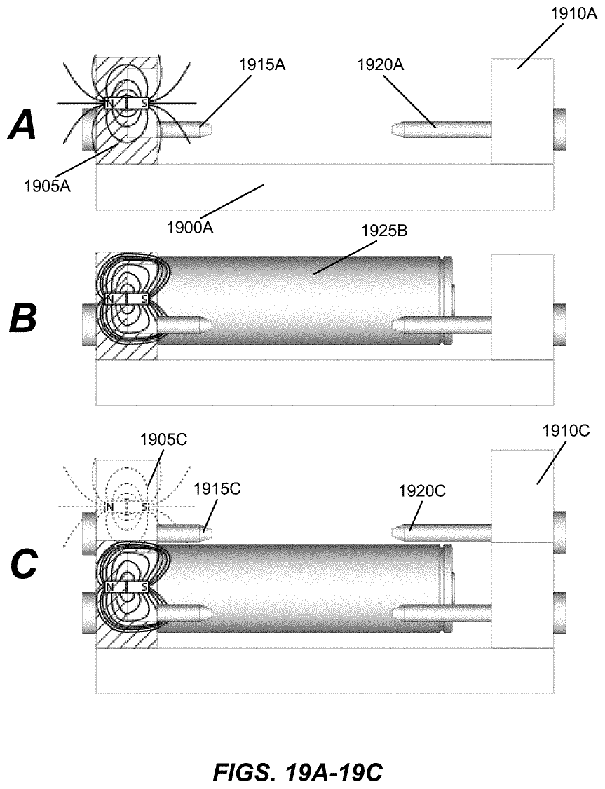

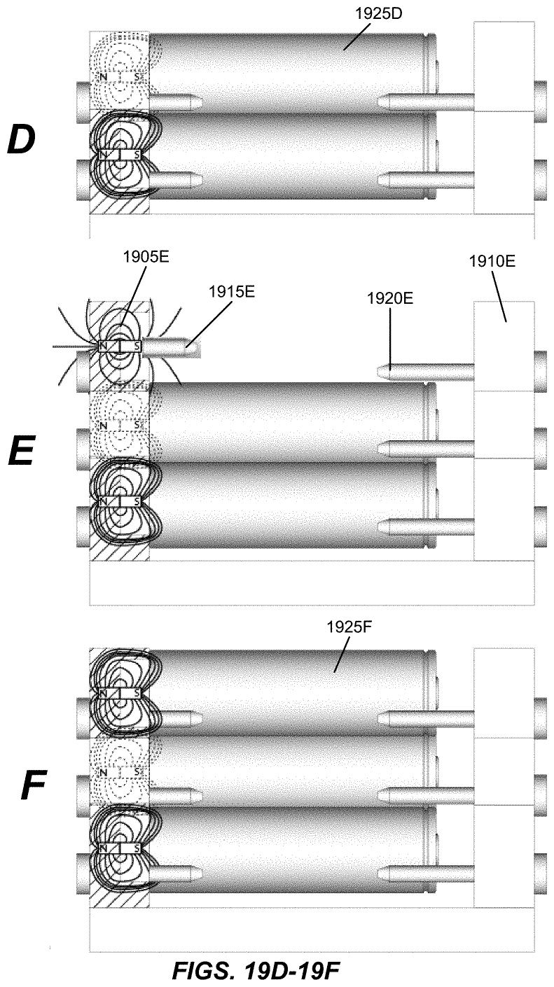

In one example implementation, the first jig tower may be comprised of a first set of stackable jigs, with each stackable jig in the first set of stackable jigs including a first set of battery cell fixation elements (e.g., pins, tabs, indents, dowels, etc.). In this case, the first set of stackable jigs can include any number of stackable jigs, and block 1805 may be performed each time a new stackable jig is added to the first jig tower. In another example implementation, the second jig tower may similarly be comprised of a second set of stackable, with each stackable jig in the second set of stackable jigs including a second set of battery cell fixation elements (e.g., pins, tabs, indents, dowels, etc.). In this case, the second set of stackable jigs can include any number of stackable jigs, and block 1810 may be performed each time a new stackable jig is added to the second jig tower. FIGS. 19A-19F depict examples whereby each of the first and second jig towers comprise respective sets of stackable jigs.

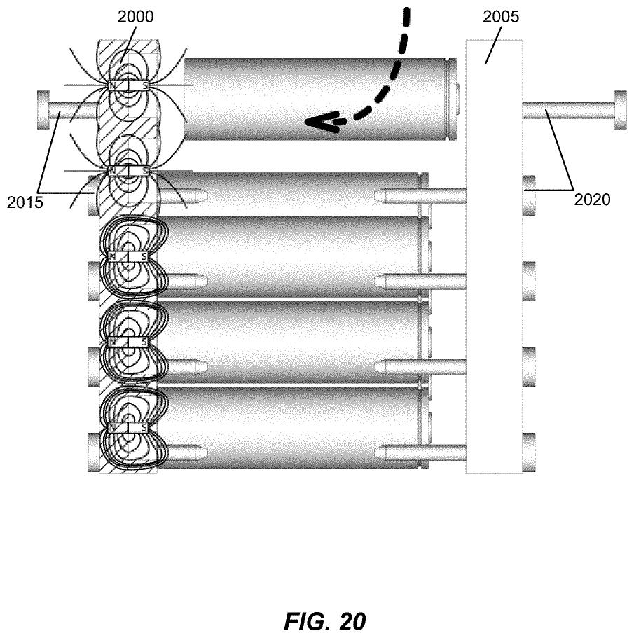

In another example implementation, the first jig tower may be comprised of a single or ‘monolithic’ side plate arranged with multiple sets of battery cell fixation elements (e.g., tabs, indents, dowels, etc.) at different heights so as to provide fixation for different rows of battery cells. In this case, at the start of the battery assembly process, fixation elements of the side plate begin in a non-inserted state. Then, as each new cell level is added, the fixation elements for securing that cell level are pushed into an inserted state to facilitate cell fixation. After all cell levels are added and permanent cell fixation is achieved (e.g., after applied glue which starts in a non-cured state has cured sufficiently, either to a partially cured state with sufficient stability, or to a fully cured state), all of the fixation elements can be transitioned back into a non-inserted state to permit the cells to be removed, at which point the cells are integrated into a battery module as discussed above. In another example implementation, the second jig tower may also be comprised of a single or ‘monolithic’ side plate arranged with multiple sets of battery cell fixation elements at different heights so as to provide fixation for different rows of battery cells. FIG. 20 depicts an example whereby each of the first and second jig towers comprise respective side plates.

In yet another example implementation, one (or more) of the first and second jig towers may comprise a set of stackable jigs, while the other of the first and second jig towers comprises a side plate arranged with multiple sets of battery cell fixation elements at different heights of the side plate so as to provide fixation for different rows of battery cells. This particular implementation is not expressly illustrated in the FIGS, but can be readily ascertained from a review of FIGS. 19A-20. For example, the stackable jigs 1905A, 1905C, etc. of FIGS. 19A-19F may be used in conjunction with side plate 2005 of FIG. 20, or the stackable jigs 1910A, 1910C, etc. of FIGS. 19A-19F may be used in conjunction with side plate 2000 of FIG. 20.

At block 1815, a set of battery cells is arranged between a first part of the first jig tower that includes a first set of battery cell fixation elements and a second part of the second jig tower that opposes the first part of the first jig tower and is arranged with a second set of battery cell fixation elements, the set of battery cells each being fixed in position at least in part by the first and second sets of fixation elements. For example, if the first and second jig towers are configured as sets of stackable jigs, then the first and second parts of the first and second jig towers may correspond to the respective top-most jigs at a current stage of battery module assembly. Example implementations of block 1815 are shown at FIGS. 6A and 9B.

At block 1820, a magnetic force is applied to each battery cell in the set of battery cells in a direction that is towards the first jig tower and away from the second jig tower. The magnetic force applied at block 1820 may be implemented as an attractive force that pulls each battery cell in the set of battery cells towards the first jig tower, a repulsive force that pushes each battery cell in the set of battery cells away from the second jig tower, or a combination thereof.

In some designs, the magnetic force is applied via the use of a magnetic-based supplemental fixation element(s). In some designs, the magnetic-based supplemental fixation element(s) may include one or more permanent magnets, which may either be integrated into the first and/or second jig towers or may simply be placed close to the first and/or second jig towers in proximity to the set of battery cells. In other designs, the magnetic-based supplemental fixation element(s) may include one or more electric magnets. One advantage of using electric magnets is their capability to be either in a switched on state (generating the magnetic force) or a switched off state (eliminating the magnetic force).

At block 1825, glue is optionally applied (e.g., in a non-cured state, after which the glue cures to a partially cured state and ultimately to a fully cured state over time) to permanently fix the set of battery cells into position while the magnetic force is being applied. At block 1830, the application of the magnetic force is optionally ceased after the glue has cured sufficiently (e.g., either to a partially cured state with sufficient stability, or to a fully cured state). In an example where the magnetic-based supplemental fixation element(s) include one or more permanent magnets, the cessation of magnetic force at block 1830 may correspond to a machine or human operator moving the one or more permanent magnets away from the set of battery cells. In an example where the magnetic-based supplemental fixation element(s) include one or more electric magnets, the cessation of magnetic force at block 1830 may correspond to a machine or human operator switching off the one or more electric magnets.

Example implementations of the process of FIG. 18 will now be described with respect to FIGS. 19A-19F, each of which depicts a battery module assembly arrangement with jig towers comprised of respective sets of stackable jigs at successive stages of assembly.

Referring to FIG. 19A, the battery module assembly arrangement includes a base plate 1900A with a first stackable jig 1905A including and a second stackable jig 1910A mounted thereon. The first stackable jig 1905A is arranged with a fixation element 1915A in an inserted state, and the first stackable jig 1910A is arranged with a fixation element 1920A in an inserted state. While not visible in the side-perspective of FIG. 19A, the first and second stackable jigs 1905A-1910A may include other similarly configured fixation elements as shown above in various FIGS (e.g., FIG. 6B, etc.)

Referring to FIG. 19A, an attractive magnetic force is generated (e.g., via a permanent magnet, an electric magnet, etc.) at the first stackable jig 1905A. As noted above, in other designs a repulsive magnetic force (or a combination of an attractive magnetic force at one jig with a repulsive magnetic force at the other jig) may be implemented.

Referring to FIG. 19B, a battery cell 1925B is added to the battery module assembly arrangement. The attractive magnetic force at the first stackable jig 1905A pulls the battery cell 1925B so as to maintain flush contact with the first stackable jig 1905A. While not shown explicitly in FIG. 19B, battery cell 1925B is part of a row of battery cells that comprises one or more additional battery cells. In this example, the attractive magnetic force is applied to each battery cell in the row of battery cells so that each respective battery cell in the row of battery cells maintains flush contact with the first stackable jig 1905A, which functions to align each battery cell in the row of battery cells.

Referring to FIG. 19C, a third stackable jig 1905C is mounted on top of the first stackable jig 1905A, and a fourth stackable jig 1910C is mounted on top of the second stackable jig 1910A. The third stackable jig 1905C is arranged with a fixation element 1915C in an inserted state, and the fourth stackable jig 1910C is arranged with a fixation element 1920C in an inserted state. While not visible in the side-perspective of FIG. 19C, the third and fourth stackable jigs 1905C-1910C may include other similarly configured fixation elements as shown above in various FIGS (e.g., FIG. 6B, etc.).

Referring to FIG. 19D, a battery cell 1925D is added to the battery module assembly arrangement. The attractive magnetic force at the third stackable jig 1905C pulls the battery cell 1925D so as to maintain flush contact with the third stackable jig 1905C. While not shown explicitly in FIG. 19D, battery cell 1925D is part of a row of battery cells that comprises one or more additional battery cells. In this example, the attractive magnetic force is applied to each battery cell in the row of battery cells so that each respective battery cell in the row of battery cells maintains flush contact with the third stackable jig 1905C, which functions to align each battery cell in the row of battery cells.

Referring to FIG. 19E, a fifth stackable jig 1905E is mounted on top of the third stackable jig 1905C, and a sixth stackable jig 1910E is mounted on top of the fourth stackable jig 1910C. The fifth stackable jig 1905E is arranged with a fixation element 1915E in an inserted state, and the sixth stackable jig 1910E is arranged with a fixation element 1920E in an inserted state. While not visible in the side-perspective of FIG. 19E, the fifth and sixth stackable jigs 1905E-1910E may include other similarly configured fixation elements as shown above in various FIGS (e.g., FIG. 6B, etc.).

Referring to FIG. 19F, a battery cell 1925F is added to the battery module assembly arrangement. The attractive magnetic force at the fifth stackable jig 1905E pulls the battery cell 1925F so as to maintain flush contact with the third stackable jig 1905E. While not shown explicitly in FIG. 19F, battery cell 1925F is part of a row of battery cells that comprises one or more additional battery cells. In this example, the attractive magnetic force is applied to each battery cell in the row of battery cells so that each respective battery cell in the row of battery cells maintains flush contact with the fifth stackable jig 1905E, which functions to align each battery cell in the row of battery cells.

The assembly process described with respect to FIGS. 19A-19F may continue as the jig tower grows level by level as more jigs (and battery cells) are added

FIG. 20 illustrates a battery module assembly arrangement based on an example implementation of the process 1800 of FIG. 18 in accordance with another embodiment of the disclosure. In contrast to FIGS. 19A-19F which construct jig towers out of respective sets of stackable (or modular) jigs, the battery module assembly arrangement of FIG. 20 includes two ‘monolithic’ side plates 2000 and 2005. As shown in FIG. 20, an attractive magnetic force is generated (e.g., via a permanent magnet, an electric magnet, etc.) at each cell level (or row) of the side plate 2000. While not shown specifically in FIG. 20, the side plates 2000 and 2005 may be mounted on a surface, such as the base plate 1900A of FIG. 19A.

In the embodiment of FIG. 20, fixation elements 2015 and 2020 are arranged inside respective holes (or openings) of the side plates 2000 and 2005, respectively, so as to be moveable (e.g., configured in either an inserted state to provide battery cell fixation, or a non-inserted state to permit battery cells to be moveable). At the start of the battery assembly process, the fixation elements 2015 and 2020 are in a non-inserted state. Then, as each new cell level is added, the fixation elements for securing that cell level are pushed into an inserted state to facilitate cell fixation. After all cell levels are added and permanent cell fixation is achieved (e.g., after applied glue has cured sufficiently, either to a partially cured state with sufficient stability, or to a fully cured state), all of the fixation elements can be transitioned back into a non-inserted state to permit the cells to be removed, at which point the cells are integrated into a battery module as discussed above. Similar to FIGS. 19A-19F, each battery cell at each cell level (or row) may be made flush with respect to the side plate 2000 such that each battery cell at each cell level (or row) is aligned with each other.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range.

While the embodiments described above relate primarily to land-based electric vehicles (e.g., cars, trucks, etc.), it will be appreciated that other embodiments can deploy the various battery-related embodiments with respect to any type of electric vehicle (e.g., boats, submarines, airplanes, helicopters, drones, spaceships, space shuttles, rockets, etc.).

The forgoing description is provided to enable any person skilled in the art to make or use embodiments of the invention. It will be appreciated, however, that the invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the embodiments of the invention.

What is claimed is:

1. A method of battery module assembly, comprising:
mounting a first jig tower on a surface;
mounting a second jig tower on the surface;
arranging a set of battery cells arranged between a first part of the first jig tower that includes a first set of battery cell fixation elements and a second part of the second jig tower that opposes the first part of the first jig tower and is arranged with a second set of battery cell fixation elements, the set of battery cells each being fixed in position at least in part by the first and second sets of fixation elements; and
applying magnetic force to each battery cell in the set of battery cells in a direction that is towards the first jig tower and away from the second jig tower.

2. The method of claim 1, wherein the first and second sets of fixation elements comprise pins.

3. The method of claim 1,
wherein the first jig tower comprises a first set of stackable jigs, and
wherein the second jig tower comprises a second set of stackable jigs.

4. The method of claim 1,
wherein the first jig tower comprises a first side plate arranged with multiple sets of battery cell fixation elements at different heights of the first side plate so as to provide fixation for rows of battery cells arranged at different heights of the first side plate, and
wherein the second jig tower comprises a second side plate arranged with multiple sets of battery cell fixation elements at different heights of the second side plate so as to provide fixation for the different rows of battery cells.

5. The method of claim 1,
wherein one of the first and second jig towers comprises a set of stackable jigs, and
wherein the other of the first and second jig towers comprises a side plate arranged with multiple sets of battery cell fixation elements at different heights of the side plate so as to provide fixation for different rows of battery cells.

6. The method of claim 1, wherein the magnetic force is an attractive force that pulls each battery cell in the set of battery cells towards the first jig tower.

7. The method of claim 1, wherein the magnetic force is a repulsive force that pushes each battery cell in the set of battery cells away from the second jig tower.

8. The method of claim 1, further comprising:
applying glue to permanently fix the set of battery cells into position while the magnetic force is being applied.

9. The method of claim 8, further comprising:
ceasing the application of the magnetic force after the glue has cured.

10. The method of claim 9,
wherein the applying includes switching on at least one electric magnet, and
wherein the ceasing includes switching off the at least one electric magnet.

11. The method of claim 1, wherein the applying includes switching on at least one electric magnet.

12. The method of claim 1, wherein the applying applies the magnetic force via at least one permanent magnet.

13. A battery module assembly arrangement, comprising:
a first jig tower mounted on a surface;
a second jig tower mounted on the surface;
a set of battery cells arranged between a first part of the first jig tower that includes a first set of battery cell fixation elements and a second part of the second jig tower that opposes the first stackable jig and is arranged with a second set of battery cell fixation elements, the set of battery cells each being fixed in position at least in part by the first and second sets of fixation elements; and
at least one magnetic-based supplemental fixation element configured to apply magnetic force to each battery cell in the set of battery cells in a direction that is towards the first jig tower and away from the second jig tower.

14. The battery module assembly arrangement of claim 13, wherein the first and second sets of fixation elements comprise pins.

15. The battery module assembly arrangement of claim 13,
wherein the first jig tower comprises a first set of stackable jigs, and
wherein the second jig tower comprises a second set of stackable jigs.

16. The battery module assembly arrangement of claim 13,
wherein the first jig tower comprises a first side plate arranged with multiple sets of battery cell fixation elements at different heights of the first side plate so as to provide fixation for different rows of battery cells, and
wherein the second jig tower comprises a second side plate arranged with multiple sets of battery cell fixation elements at different heights of the second side plate so as to provide fixation for the different rows of battery cells.

17. The battery module assembly arrangement of claim 13,
wherein one of the first and second jig towers comprises a set of stackable jigs, and
wherein the other of the first and second jig towers comprises a side plate arranged with multiple sets of battery cell fixation elements at different heights of the side plate so as to provide fixation for different rows of battery cells.

18. The battery module assembly arrangement of claim 13, wherein the magnetic force is an attractive force that pulls each battery cell in the set of battery cells towards the first jig tower.

19. The battery module assembly arrangement of claim 13, wherein the magnetic force is a repulsive force that pushes each battery cell in the set of battery cells away from the second jig tower.

20. The battery module assembly arrangement of claim 13, further comprising:
glue in a non-cured, partially cured or fully cured state that is configured to permanently fix the set of battery cells into position when fully cured.

21. The battery module assembly arrangement of claim 13, wherein the at least one magnetic-based supplemental fixation element includes at least one electric magnet that is switched on.

22. The battery module assembly arrangement of claim 13, wherein the at least one magnetic-based supplemental fixation element includes at least one permanent magnet.
